(19) United States
(12) Patent Application Publication
(10) Pub. No.: US 2025/0050360 A1
(43) Pub. Date: Feb. 13, 2025

(54) BACKPACK SPRAYER LAYOUT

(71) Applicant: Milwaukee Electric Tool Corporation, Brookfield, WI (US)

(72) Inventor: Simo Huhtanen, Brookfield, WI (US)

(21) Appl. No.: 18/794,069

(22) Filed: Aug. 5, 2024

Related U.S. Application Data
(60) Provisional application No. 63/531,898, filed on Aug. 10, 2023.

(51) Int. Cl. B05B 9/08

(52) U.S. Cl. CPC B05B 9/0861; B05B 9/0888

(57) ABSTRACT

A backpack fluid dispenser is provided. The backpack fluid dispenser comprising: a fluid container and a base coupled to the fluid container. The base comprises a housing body, a battery compartment in the housing body for receiving a battery, and a motor compartment housing a motor. The fluid dispenser includes a pump assembly fluidly coupled with the fluid container, a support assembly configured to support the fluid container, base, and pump assembly. The fluid dispenser includes a dispensing assembly for dispensing fluid from the container. The pump assembly is configured to pump the fluid from the fluid container to the dispensing assembly. The battery compartment is disposed below the pump assembly in a vertical direction.

### CROSS-REFERENCE TO RELATED APPLICATIONS

The present application claims priority to U.S. Provisional Patent Application Ser. No. 63/531,898 filed on Aug. 10, 2023, the disclosure of which is incorporated by reference herein in its entirety.

### FIELD

The present disclosure relates generally to a backpack sprayer, and more particularly to a portable fluid dispenser with improved ergonomic design.

### BACKGROUND

Backpack sprayers are used for dispensing different fluids in a wide variety of applications. For example, the backpack sprayers can be used to dispense water, cleaning fluid, sanitizer, weed killer, pesticide, fertilizer, paint, and other fluid to an object or a surface. In general, backpack sprayers are designed to be worn by the user by securing a tank of the sprayer against the user's back, such that the user can easily carry the tank of fluid from location to location.

However, backpack sprayers may be heavy, and may have unevenly distributed weight. A typical electric backpack sprayer may include a battery, a motor, and a pump, each adding weight to the tool. Moreover, the liquid contents of the backpack sprayer can add considerable weight to the tool, affecting the center of gravity of the tool. The further away from the user's body that the tank is located, the further away the sprayer's center of gravity is for the user, thereby increasing the difficulty to carry or use the backpack sprayer.

Accordingly, improved backpack sprayers are desired in the art. In particular, backpack sprayers which provide enhanced ergonomic and comfortable design for a user would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a backpack fluid dispenser is provided. The backpack fluid dispenser includes a fluid container and a base coupled to the fluid container. The base comprises a housing body, a battery compartment in the housing body for receiving a battery, and a motor compartment housing a motor. The fluid dispenser includes a pump assembly fluidly coupled with the fluid container, a support assembly configured to support the fluid container, base, and pump assembly. The fluid dispenser includes a dispensing assembly for dispensing fluid from the container. The pump assembly is configured to pump the fluid from the fluid container to the dispensing assembly. The battery compartment is disposed below the pump assembly in a vertical direction.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a backpack fluid dispenser in accordance with embodiments of the present disclosure;

FIG. 2 is a perspective view of the base of a backpack fluid dispenser in accordance with embodiments of the present disclosure;

FIG. 3 is a rear view of a backpack fluid dispenser with a cover panel removed in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a backpack fluid sprayer has a fluid container that sits on a base, and the base contains a battery and a motor. The backpack fluid sprayer further includes a pump assembly driven by the motor and powered by the battery. The pump assembly, motor, and battery are vertically arranged from top to bottom and spaced away from a user's back relative to the fluid container. By providing the fluid container and thereby the contents of the fluid container closest to the user, the center of gravity of the backpack sprayer may be brought closer to the user's body, thereby providing a more ergonomic and comfortable backpack sprayer.

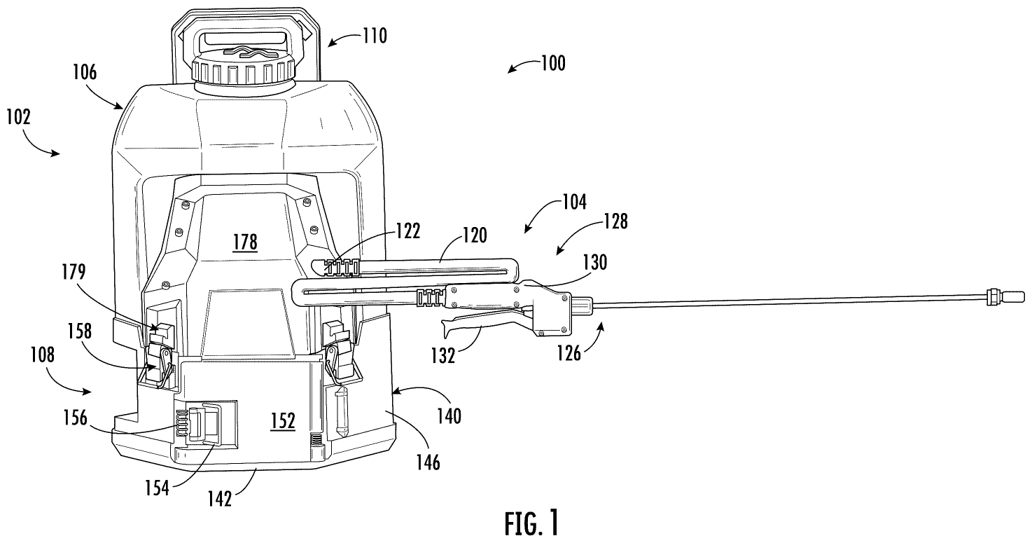

Referring now to the drawings, FIG. 1 illustrates a backpack fluid dispenser 100, also known as a backpack sprayer, comprising a backpack assembly 102 and a dispensing assembly 104. The backpack assembly 102 is configured to be supported on the user's back such that the user can easily carry the backpack sprayer 100 from location to location. The backpack assembly 102 includes a fluid container 106 and a base 108 that are supported by a support assembly 110.

The support assembly 110 may include one or more shoulder straps (not shown) secured to the fluid container 106 and/or the base 108. For instance, the fluid container 106 and/or the base 108 may include one or more strap harnesses at which the shoulder strap(s) may be attached. It is apparent that the shoulder strap(s) may be attached to any number of strap harnesses, which may be formed integrally and molded as a part of the fluid container 106 and/or base 108. Alternatively, the strap harness may also be glued, bonded, or fastened to the fluid container 106 and/or base 108. The support assembly 110 may further include a sternum strap (not shown) attached to two shoulder straps and configured to extend across the chest of the user, thus the sternum strap can keep the backpack sprayer 100 tightly in place relative to the user's body and prevent the shoulder straps from sliding off the shoulders of the user.

The fluid container 106 is a storage tank configured to carry water or other liquids for dispensing, such as but not limited to cleaning fluid, sanitizer, weed killer, pesticide, fertilizer, paint, and other fluid. The fluid container 106 may be constructed using light weight and durable materials which show excellent resistance to a wide range of chemicals, such as synthetic resin and polyester resin. The fluid container 106 may be transparent or semi-transparent, and in some aspects of the invention, a plurality of volume indicators may be provided on a side wall of the fluid container 106 to indicate the amount of fluid contained in the fluid container 106. The volume indicators may indicate the lever in gallons, liters, or other desirable measuring units.

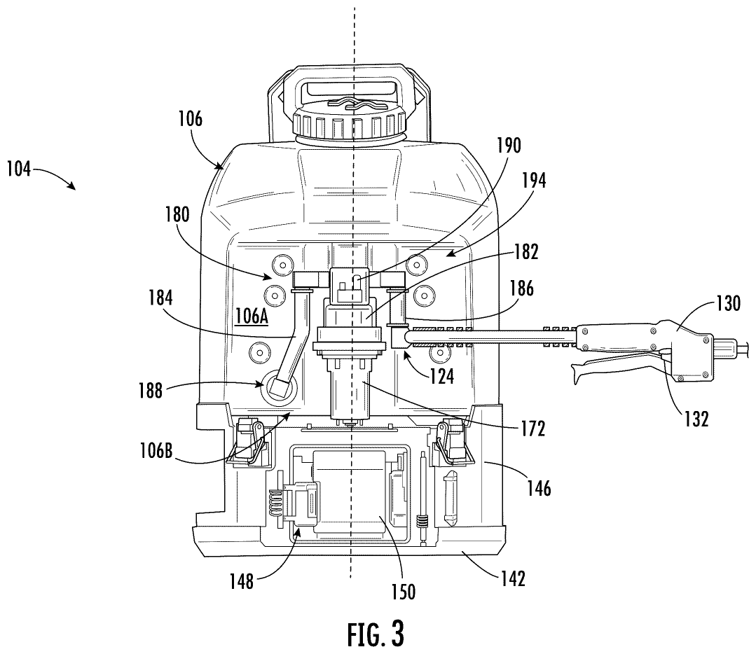

The dispensing assembly 104 is in fluid communication with the fluid container 106 by connecting a hose 120 thereto for dispensing the fluid from the fluid container 106. A fluid channel 124 (see FIG. 3) extending from the fluid container 106 may be provided with a connector 122. As illustrated in the figures, the dispensing assembly 104 can be fluidly coupled with the fluid container 106 by coupling the dispensing assembly 104 to the connector 122. The connector 122 can have any shapes, such as rectangular, round, oval, or other shapes with a cavity sufficient for gripping the hose 120 and securing it thereon. At an opposite end of the hose 120, a nozzle 126 may be provided to dispense fluid therefrom. A trigger assembly 128 may be provided comprising a handle 130 and a trigger 132 configured to control the dispensing of fluid through the nozzle 126.

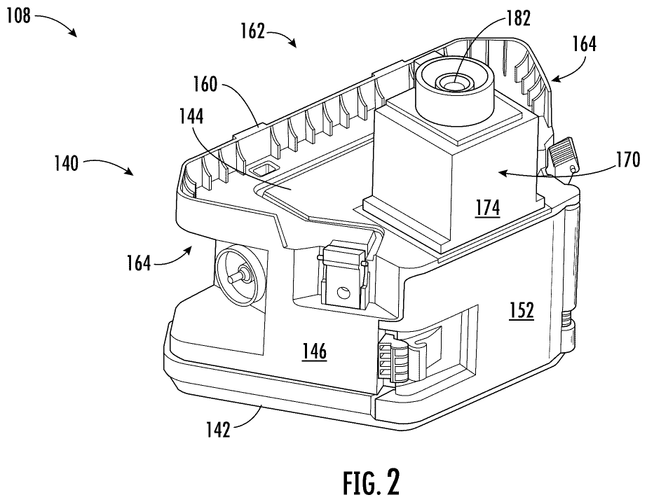

Turning back to the backpack assembly 102, the base 108 comprises a housing body 140. The housing body 140 has a bottom surface 142, an upper surface 144 (see FIG. 2), and sidewalls 146 extending around the sides of the housing body 140 between the bottom surface 142 and the upper surface 144. The housing body 140 encloses a battery compartment 148 configured to receive a battery 150. The battery compartment 148 may include a door 152 coupled to the sidewalls 146 configured to provide access into the battery compartment 148, e.g., to insert or remove the battery. The door 152 may include a latch 154 and the sidewall 146 may include a complementary receiving portion 156 configured to receive the latch 154 to secure the door 152 in a closed position.

As best seen in FIG. 3, the fluid container 106 is configured to sit on top of the upper surface 144 of the housing body 140. For instance, a bottom surface 106B of the fluid container 106 may be complementarily sized and shaped to be received by the upper surface 144 of the housing body 140. Further, the housing body 140 may have a lip 160 extending upward from the upper surface 144 around at least a portion of a perimeter of the upper surface 144. As shown in FIG. 2, the lip 160 may extend along an inner surface 162 and one or more side surfaces 164 of the housing body 140. In this manner, the lip 160 may retain the fluid container 106 in place on the upper surface 144 of the housing body 140.

In addition to the battery compartment 148, the base 108 may include a motor compartment 170 enclosing a motor 172. The motor 172 is powered by the battery 150. The motor compartment 170 may be incorporated into the housing body 140 and/or the motor compartment 170 may be distinct from the housing body 140. As shown in FIGS. 2 and 3, the motor 172 and motor compartment 170 may extend outside the housing body 140 of the base 108. For instance, the motor compartment 170 may have a motor cover 174 configured to be disposed on an outer side of the backpack assembly 102, i.e., away from the support assembly 110.

The backpack assembly 102 further includes a pump assembly 180. The pump assembly 180 includes a pump 182 that is driven by the motor 172 to dispense fluid from the fluid container 106 to the dispensing assembly 104. More specifically, the pump assembly 180 may include an inlet channel 184, e.g., a hose, configured to provide fluid from the fluid container 106 to the pump 182 and an outlet channel 186, e.g., a hose, configured to deliver fluid from the pump 182 to the dispensing assembly 104. The fluid container 106 may include a dispensing opening 188 at which the inlet channel 184 is coupled. The dispensing opening 188 may be disposed on a side surface 106A or a lower surface 106B of the fluid container 106. When the dispensing opening 188 is on a side surface 106A of the fluid container 106, the dispensing opening 188 may be near or adjacent to the lower surface 106B such that the fluid container 106 is configured to dispense fluid until the fluid container 106 is nearly or entirely empty of fluid. The dispensing opening 188 may be disposed on an outer side of the fluid container 106 relative to the support assembly 110.

In some aspects of the present invention, the pump 182 may be disposed in or on the motor compartment 170 described above. When the backpack assembly 102 is assembled, the pump 182 may be fluidly connected to a pump connector 190 disposed between the inlet channel 184 and outlet channel 186.

An outer cover panel 178 may be provided to cover the motor 172, motor compartment 170, and pump assembly 180. For instance, the outer cover panel 178 may extend generally upward in a vertical direction from the housing body 140 on an outer side of the housing body 140 (i.e., an opposite side from the support assembly 110). The outer cover panel 178 may enclose the motor compartment 170 and pump assembly 180 between the housing body 140 and the fluid container 106. The outer cover panel 178 may be removably coupled to the fluid container 106 and the housing body 140, e.g., by coupling elements such as latches or other suitable means to secure the outer cover panel 178 in place. For instance, one or more coupling elements 158, e.g., latches, may be provided on the housing body 140 and configured to couple with one or more complementary receiving elements 179 of the cover panel 178 to secure the cover panel in place. Moreover, as the cover panel 178 further contacts and may be secured to the fluid container 106, securing the cover panel 178 to the housing body 140 may aid in further maintaining the fluid container 106 in place relative to the base 108.

As illustrated in FIGS. 2 and 3, the motor compartment 170 may be disposed directly above the battery compartment 148 in a vertical direction such that the motor 172 is disposed directly above the battery 150. The motor 172 may be oriented along a vertical axis, e.g., a rotation axis of the motor 172 may extend vertically.

Further, the pump 182 may be disposed directly above the motor 172. For instance, the pump 182 and the motor 172 may share a common axis, e.g., the vertical axis described above. In this arrangement, the pump 182, the motor 172, and the battery 150 may be vertically arranged from top to bottom.

As illustrated in FIG. 3, at least a portion of the pump assembly 180 and motor compartment 170 are disposed adjacent to the fluid container 106 in a horizontal direction. For instance, the fluid container 106 may have an indented section 194 configured to receive the pump assembly 180 and motor compartment 170. In this manner, the backpack assembly 102 may have a more compact size and arrangement than, for instance, providing the pump assembly 180 and motor compartment 170 below the fluid container 106 in a vertical direction.

Moreover, the pump assembly 180 and motor compartment 170 may be disposed toward an outer side of the backpack assembly 102 relative to the support assembly 110 on the inner side of the backpack assembly 102. In this manner, the fluid container 106 may be disposed nearer to the support assembly 110 than the motor 172 and pump 182. In other words, the fluid container 106 may be between the support assembly 110 and the pump assembly 180.

Typically, the fluid container 106 may be the heaviest component of the backpack assembly 102 when full of liquid. In the arrangement illustrated in FIGS. 1 and 3, by providing the fluid container 106 and thereby the contents of the fluid container 106 closest to the support assembly 110, the center of gravity of the backpack assembly 102 may be brought closer to the user's body, thereby providing a more ergonomic and comfortable backpack assembly 102 for the backpack sprayer 100.

Further aspects of the invention are provided by one or more of the following embodiments:

A backpack fluid dispenser comprising: a fluid container and a base coupled to the fluid container. The base comprises a housing body, a battery compartment in the housing body for receiving a battery, and a motor compartment housing a motor. The fluid dispenser includes a pump assembly fluidly coupled with the fluid container, a support assembly configured to support the fluid container, base, and pump assembly. The fluid dispenser includes a dispensing assembly for dispensing fluid from the container. The pump assembly is configured to pump the fluid from the fluid container to the dispensing assembly. The battery compartment is disposed below the pump assembly in a vertical direction.

The backpack fluid dispenser of any one or more of the embodiments, wherein the battery compartment is disposed below the fluid container in the vertical direction.

The backpack fluid dispenser of any one or more of the embodiments, wherein the pump assembly comprises a pump configured to be driven by the motor, the motor being disposed below the pump in the vertical direction.

The backpack fluid dispenser of any one or more of the embodiments, wherein the pump, the motor, and the battery compartment are arranged top to bottom along a common axis.

The backpack fluid dispenser of any one or more of the embodiments, wherein the support assembly is disposed at an inner side of the fluid container and an inner side of the housing body.

The backpack fluid dispenser of any one or more of the embodiments, the battery compartment comprising a door at an outer side of the housing body opposite the inner side of the housing body.

The backpack fluid dispenser of any one or more of the embodiments, the pump assembly being disposed at an outer side of the fluid container opposite the inner side of the fluid container.

The backpack fluid dispenser of any one or more of the embodiments, wherein at least a portion of the pump assembly and the fluid container are adjacent to each other in the vertical direction.

The backpack fluid dispenser of any one or more of the embodiments, wherein the fluid container is positioned between the support assembly and the pump assembly.

The backpack fluid dispenser of any one or more of the embodiments, the pump assembly and the dispensing assembly being coupled by a hose, the hose extending from the pump assembly at a location above the motor.

The backpack fluid dispenser of any one or more of the embodiments, the housing body comprising an upper surface configured to receive a lower surface of the fluid container thereon.

The backpack fluid dispenser of any one or more of the embodiments, wherein the motor extends outside the housing body of the base.

The backpack fluid dispenser of any one or more of the embodiments, further comprising a cover panel configured to cover the pump assembly such that the pump assembly is enclosed between the housing body, the cover panel, and the fluid container.

The backpack fluid dispenser of any one or more of the embodiments, the base comprising one or more coupling elements on an upper side of the housing body and the cover panel comprising one or more complementary receiving elements, the coupling elements being configured to couple with the receiving elements to secure the cover panel in place relative to the housing body.

An apparatus as shown and described in one or more embodiments herein.

A system configured to operate in accordance with any one or more of the embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A backpack fluid dispenser comprising:
a fluid container;
a base coupled to the fluid container, the base comprising: a housing body, a battery compartment in the housing body for receiving a battery, and a motor compartment housing a motor;
a pump assembly fluidly coupled with the fluid container;
a support assembly configured to support the fluid container, base, and pump assembly; and
a dispensing assembly for dispensing fluid from the container;
the pump assembly being configured to pump the fluid from the fluid container to the dispensing assembly; and
the battery compartment is disposed below the pump assembly in a vertical direction.

2. The backpack fluid dispenser of claim 1, wherein the battery compartment is disposed below the fluid container in the vertical direction.

3. The backpack fluid dispenser of claim 1, wherein the pump assembly comprises a pump configured to be driven by the motor, the motor being disposed below the pump in the vertical direction.

4. The backpack fluid dispenser of claim 3, wherein the pump, the motor, and the battery compartment are arranged top to bottom along a common axis.

5. The backpack fluid dispenser of claim 1, wherein the support assembly is disposed at an inner side of the fluid container and an inner side of the housing body.

6. The backpack fluid dispenser of claim 5, the battery compartment comprising a door at an outer side of the housing body opposite the inner side of the housing body.

7. The backpack fluid dispenser of claim 5, the pump assembly being disposed at an outer side of the fluid container opposite the inner side of the fluid container.

8. The backpack fluid dispenser of claim 5, wherein at least a portion of the pump assembly and the fluid container are adjacent to each other in the vertical direction.

9. The backpack fluid dispenser of claim 1, wherein the fluid container is positioned between the support assembly and the pump assembly.

10. The backpack fluid dispenser of claim 1, the pump assembly and the dispensing assembly being coupled by a hose, the hose extending from the pump assembly at a location above the motor.

11. The backpack fluid dispenser of claim 1, the housing body comprising an upper surface configured to receive a lower surface of the fluid container thereon.

12. The backpack fluid dispenser of claim 11, wherein the motor extends outside the housing body of the base.

13. The backpack fluid dispenser of claim 1, further comprising a cover panel configured to cover the pump assembly such that the pump assembly is enclosed between the housing body, the cover panel, and the fluid container.

14. The backpack fluid dispenser of claim 13, the base comprising one or more coupling elements on an upper side of the housing body and the cover panel comprising one or more complementary receiving elements, the coupling elements being configured to couple with the receiving elements to secure the cover panel in place relative to the housing body.
